(19) United States
(12) Patent Application Publication
(10) Pub. No.: US 2012/0125166 A1
(43) Pub. Date: May 24, 2012

(54) CLEAVERS FOR CLEAVING OPTICAL FIBERS, AND RELATED BLADES, COMPONENTS, AND METHODS

(76) Inventors: Bradley E. Hallett, Watauga, TX (US); Joshua D. Raker, Lewisville, TX (US)

(21) Appl. No.: 13/112,434

(22) Filed: May 20, 2011

Related U.S. Application Data
(60) Provisional application No. 61/416,419, filed on Nov. 23, 2010.
(60) Provisional application No. 61/416,448, filed on Nov. 23, 2010.

(51) Int. Cl. B26D 1/00; B23D 35/00; B23Q 3/00; G02B 6/00

(52) U.S. Cl. 83/13; 385/137; 83/673; 269/289 R

(57) ABSTRACT

Embodiments disclosed in the detailed description include cleavers for cleaving optical fibers, and related blades, components, and methods. In this regard in one embodiment, a cleaver for cleaving an optical fiber is provided. The cleaver comprises a body and an actuator disposed in the body and configured to be actuated along an actuation path to move a blade in an at least partially arcuate cleaving path. The cleaver also comprises an optical fiber path disposed in the body and intersecting with the at least partially arcuate cleaving path, such that an end portion of an optical fiber disposed in the optical fiber path is cleaved when the actuator is actuated, moving the blade in the at least partially arcuate cleaving path and contacting the end portion of the optical fiber. Related methods and other cleaver components and related methods are disclosed.

### RELATED APPLICATION

The application claims the benefit of priority under 35 U.S.C. §119 of U.S. Provisional Application Ser. No. 61/416,419 filed on Nov. 23, 2010, and U.S. Provisional Application Ser. No. 61/416,448 filed on Nov. 23, 2010, the content of which is incorporated herein by reference in their entirety.

### BACKGROUND

1. Field of the Disclosure

The technology of the disclosure relates to cleavers and methods of cleaving optical fibers to provide an end face on the optical fibers for fiber optic termination preparations.

2. Technical Background

Optical fibers can be used to transmit or process light in a variety of applications. Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support interconnections.

Optical communication networks involve termination preparations to establish connections between disparate optical fibers. For example, optical fibers can be spliced together to establish an optical connection. Optical fibers can also be connectorized with fiber optic connectors that can be plugged together to establish an optical connection. In either case, it may be necessary for a technician to establish the optical connection in the field. The technician cleaves the optical fiber to prepare an end face on the optical fiber. The technician may employ a cleaver that includes a blade to score, scribe, or otherwise induce a flaw in the glass of the optical fiber. Inducing a flaw in the glass of an optical fiber precedes breaking the glass at the flaw to produce an end face. The blade may either by pressed into the glass or swiped across the glass to induce the flaw. The end face can then either be spliced to another optical fiber or connectorized with a fiber optic connector to establish an optical connection.

Blades for cleaving optical fibers typically employ a hardened material(s), such as diamond, sapphire, ruby, ceramics, steel, and carbide as examples, disposed on an outer surface of the blade to induce a flaw in an optical fiber. Cleaving apparatuses, referred to as cleavers, are employed to support the blades for cleaving optical fibers. The cleavers typically include an optical fiber support to hold an optical fiber in place. A movable member in the cleaver that holds the blade can then be actuated to place the blade in contact with an optical fiber to induce a flaw in the optical fiber. In this regard, the cleaver blade needs to include an extremely sharp edge to minimize the size of the flaw induced in the glass to reduce the risk of damaging the core of the optical fiber to provide efficient light transfer. Otherwise, a larger flaw may be induced in the core thus creating a poor end face for efficient optical light transfer. However, as the blade is repeatedly used for cleaving, the blade must either be disposed or sharpened if the blade is made from a material that can be sharpened. Blades made from a material that can be sharpened are typically expensive. Also, maintenance must be provided to keep the blade sufficiently sharp after repeated use, or run the risk of inducing larger flaws in an optical fiber.

### SUMMARY OF THE DETAILED DESCRIPTION

Embodiments disclosed in the detailed description include cleavers for cleaving optical fibers, and related blades, components, and methods. In this regard in one embodiment, a cleaver for cleaving an optical fiber is provided. The cleaver comprises a body. The cleaver also comprises an actuator disposed in the body and configured to be actuated along an actuation path to move a blade in an at least partially arcuate cleaving path. The cleaver also comprises an optical fiber path disposed in the body and intersecting with the at least partially arcuate cleaving path, such that an end portion of an optical fiber disposed in the optical fiber path is cleaved when the actuator is actuated, moving the blade in the at least partially arcuate cleaving path and contacting the end portion of the optical fiber.

In another embodiment, a method of cleaving an optical fiber is provided. The method comprises disposing an end portion of an optical fiber along an optical fiber path disposed in a body of a cleaver. The method also comprises actuating an actuator disposed in the body to cause a blade to move in a generally arcuate cleaving path, the generally arcuate cleaving path intersecting with the optical fiber path in a first direction swiping the blade across the end portion of the optical fiber.

In another embodiment, a cleaving stage platform for an optical fiber cleaver is provided. The optical fiber cleaver comprises a support platform. The support platform comprises a first member disposed along a first axis. The support platform also comprises a second member disposed along a second axis associated with the first axis. The support platform also comprises an opening disposed between the first member and the second member. The support platform also comprises a bridge member, the bridge member connected to first ends of the first member and the second member. The optical fiber cleaver also comprises a clamp platform, the clamp platform disposed along a third axis in the opening. The optical fiber cleaver also comprises a living hinge, the living hinge disposed between the bridge member and a first end of the clamp platform such that the clamp platform is resiliently deflectable and movable relative to the bridge member inside in the opening when a clamping force is applied to the clamp platform.

In another embodiment, a fiber clamp mechanism for clamping an optical fiber in a cleaver is provided. The fiber clamp mechanism comprises an actuator. The fiber clamp mechanism also comprises a moveable fiber clamp configured to clamp an optical fiber disposed in an optical fiber path in a cleaver when actuated. The fiber clamp also comprises a clamp extension member disposed in the actuator and configured to apply a clamping force to the movable fiber clamp to clamp an end portion of an optical fiber disposed in the optical fiber path in the cleaver.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is an exemplary imbedded carrier blade employing a straight blade edge section and an exemplary method for cleaving an optical fiber by creating a flaw in a portion of the optical fiber using the imbedded carrier blade;

FIG. 2 is an exemplary end face of the optical fiber of FIG. 1 after being cleaved using an exemplary imbedded carrier blade;

FIG. 3 is an exemplary imbedded carrier blade employing an arcuate blade edge section and an exemplary method for cleaving an optical fiber by creating a flaw in a portion of the optical fiber using the imbedded carrier blade;

FIG. 4A is a camera image of an end face of a cleaved optical fiber cleaved using an imbedded carrier blade to illustrate an exemplary quality of the surface of the end face;

FIG. 4B is an image of an interference pattern of interference generated by an interferometer captured at the focal plane of an imaging device from the end face of the cleaved optical fiber in FIG. 4A to illustrate an exemplary quality of the surface of the end face;

FIG. 4C is a surface topography map of the end face of the cleaved optical fiber in FIG. 4A to illustrate an exemplary quality of the surface of the end face;

FIG. 4D is a perspective view of the end face of the cleaved optical fiber in FIG. 4A to illustrate an exemplary quality of the surface of the end face;

FIG. 5A is a right perspective view of an exemplary cleaver and showing internal components of the cleaver configured to actuate a supported blade, including but not limited to an imbedded carrier blade, in an at least partially arcuate cleaving path to cleave an optical fiber disposed in an optical fiber path in the cleaver;

FIG. 5B is a left perspective view of the exemplary cleaver in FIG. 5A;

FIG. 5C is an exploded view of the cleaver in FIG. 5A;

FIG. 5D is a front view of an exemplary cleaver in FIG. 5A and showing internal components of the cleaver;

FIG. 6 is a rear perspective view of a body of the cleaver in FIGS. 5A-5D;

FIGS. 7A-7C are right perspective, front, and top views, respectively, of a cleaving stage platform attached to a left-side end cap and disposed inside the cleaver body in the cleaver in FIGS. 5A-5D to support an end portion of an optical fiber to be cleaved;

FIGS. 8A and 8B are right and left perspective views, respectively, of a right-side end cap disposed inside the cleaver body in the cleaver in FIGS. 5A-5D to support the cleaving stage platform and provide a fiber receiver to receive and dispose an end portion of an optical fiber in an optical fiber path in the cleaving stage platform for cleaving;

FIG. 9A is a left side perspective view of the cleaver in FIGS. 5A-5D with an end portion of an optical fiber disposed in the cleaver body and disposed in the optical fiber path in the cleaver to be cleaved;

FIG. 9B is a side close-up view of the cleaver in FIGS. 5A-5D with an actuator actuated to move the blade edge of the blade in an at least partially arcuate cleaving path across a cleaving channel in the cleaver and in contact with the end portion of the optical fiber disposed in the optical fiber path of the cleaver;

FIG. 10 is a right perspective view of fiber clamp mechanism of the cleaver in FIGS. 5A-5D;

FIG. 11A is a right side view of the cleaver in FIGS. 5A-5D with the left-side end cap removed to show the position of the blade when the actuator is not actuated;

FIG. 11B is a right side view of the cleaver in FIGS. 5A-5D with the actuator initially actuated to begin to move the blade in the at least partially arcuate path to pass through a cleaving channel and intersect with an optical fiber path disposed in the cleaver;

FIG. 11C is a right side view of the cleaver in FIGS. 5A-5D with the actuator further actuated from the actuation position in FIG. 11B where the blade edge of the blade is passing through a cleaving channel and intersecting with an optical fiber path disposed in the cleaver to score an end portion of the optical fiber;

FIG. 11D is a right side view of the cleaver in FIGS. 5A-5D with the actuator further actuated beyond the actuation position in FIG. 11C to move the blade in the at least partially arcuate path past the cleaving position in the cleaver in FIG. 11C;

FIG. 11E is a right side view of the cleaver in FIGS. 5A-5D with the actuator fully actuated to move the blade in the at least partially arcuate path past the cleaving channel in a fully articulated position in the cleaver;

FIGS. 12A and 12B are right perspective and front views, respectively, of an actuator for the cleaver in FIGS. 5A-5D;

FIG. 13 is a right perspective view of a blade arm of the cleaver in FIGS. 5A-5D;

FIG. 14A is a right perspective view of an alternative exemplary cleaver configured to support a blade, including an imbedded carrier blade, to cleave optical fibers, without an optical fiber to be cleaved supported therein; and

FIG. 14B is a right perspective view of the cleaver in FIG. 14A supporting an optical fiber to be cleaved with a blade supported therein, including an imbedded carrier blade.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include imbedded carrier blades for cleaving optical fibers and related cleavers and methods. In one embodiment, the blade includes a carrier body that defines a blade edge. At least one cleaving material is imbedded into at least a portion of the carrier body. The at least one cleaving material is additionally exposed on at least a portion of the blade edge to induce a flaw in a portion of an optical fiber contacted by the blade edge. The portion of the optical fiber can be broken about the induced flaw to create an end face for fiber optic termination preparations. Cleaving the optical fiber prepares an end face on the optical fiber to prepare fiber optic terminations, including in the field. The imbedded carrier blade can be disposed in a cleaver to cleave an optical fiber. Methods of cleaving an optical fiber using an imbedded carrier blade are also provided.

The imbedded carrier blade may be produced from a carrier loaded with a hardened material(s) to induce a flaw in an optical fiber. As a non-limiting example, the hardened material(s) may be a hardened mineral(s) imbedded into a carrier to provide a mineral-loaded carrier as the blade. As a non-limiting example, as the carrier in the blade is worn due to repeated use, the mineral imbedded within the carrier may continue to be exposed on the blade edge, thereby keeping the blade edge viable for inducing a flaw in a portion of an optical fiber. In this manner, the cost of the blade may be reduced by avoiding the need for sharpening. The imbedded carrier blade may also employ a carrier material(s) sufficiently inexpensive to allow the carrier blade to be disposable.

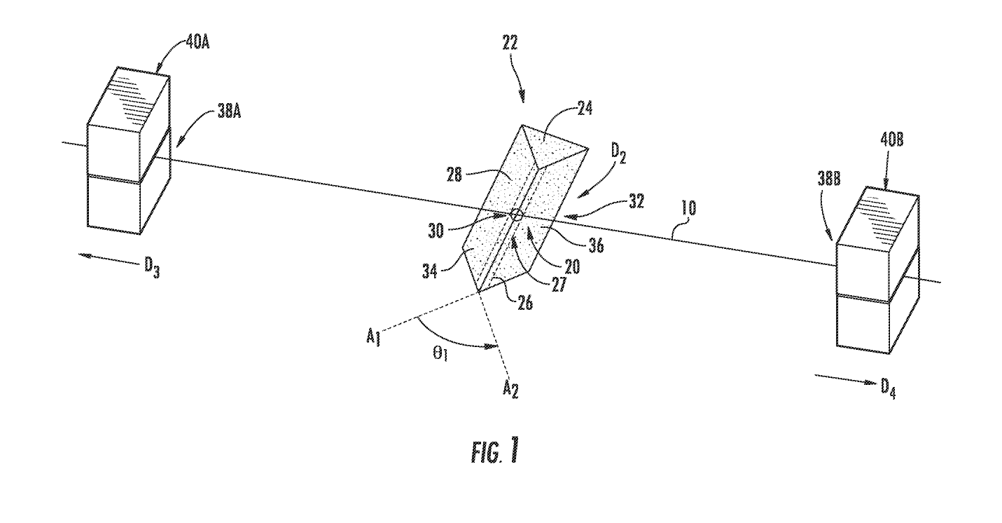

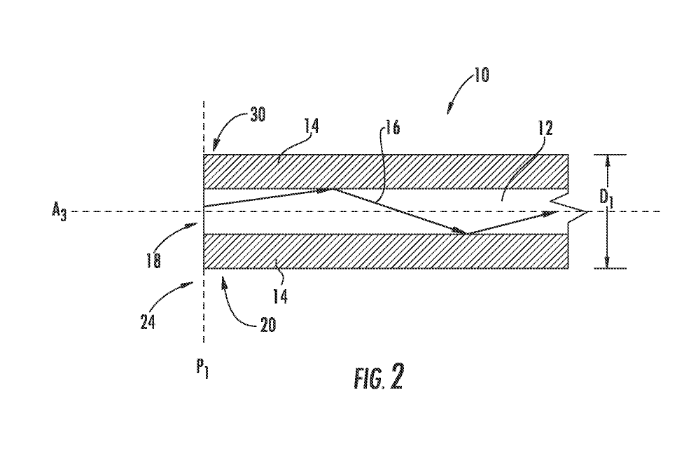

In this regard, FIG. 1 is an exemplary carrier blade and method of using the carrier blade for cleaving an optical fiber by creating or inducing a flaw in a portion of the optical fiber using an abrasive medium. As illustrated in FIG. 1, an optical fiber 10 is provided. The optical fiber 10 can be any type of optical fiber, including but not limited to a single-mode optical fiber and a multi-mode optical fiber. The optical fiber 10 may be of any size diameter D₁, as illustrated in FIG. 2. The optical fiber 10 may include a core 12 surrounded by cladding 14 to provide total internal reflection (TIR) of light 16 propagated down the core 12, as illustrated in FIG. 2. The cladding 14 may be provided as glass or other material, including but not limited to a polymer cladding, such as a plastic clad silica as an example. An outer coating (not shown) may be disposed around the cladding 14. The optical fiber 10 may be provided as part of a single fiber or multi-fiber fiber optic cable.

When splicing or connectorizing the optical fiber 10, an end face 18 is placed on an end portion 20 of the optical fiber 10, as illustrated in FIG. 2. The end face 18 is aligned with an end face of another optical fiber to transfer the light 16 from the optical fiber 10 to the spliced or connected optical fiber. When splicing or connectorizing an optical fiber, it is important to provide an end face 18 that is smooth and mirror-like to achieve an efficient light transfer. It is also important to avoid damaging the core 12 and/or the cladding 14 of the optical fiber 10. In this regard, the optical fiber 10 is cleaved to prepare the end face 18. The end face 18 is prepared by introducing a flaw into the end portion 20 of the optical fiber 10. A blade is typically employed to score the end portion 20 of the optical fiber to introduce a flaw into the end portion 20 of the optical fiber 10. Then, the end face 18 is formed when the end portion 20 of the optical fiber 10 is broken about the induced flaw to cleave the optical fiber 10.

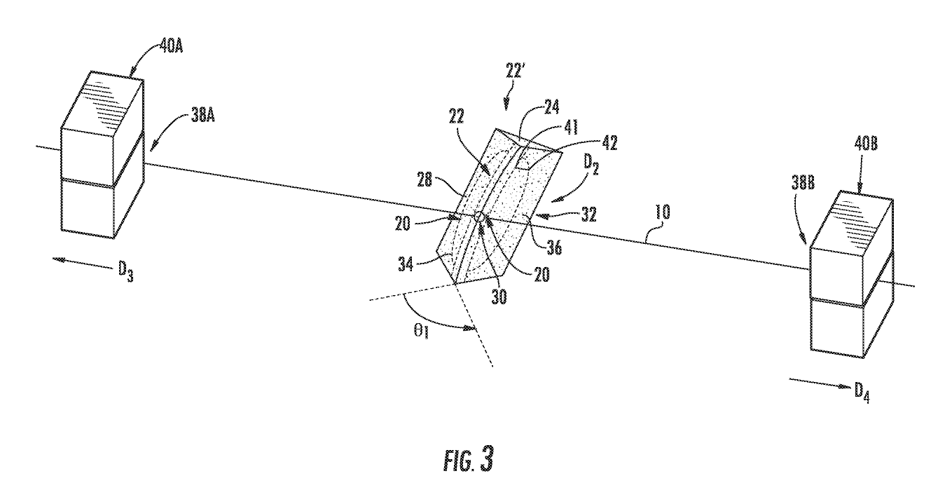

In this embodiment, an imbedded carrier blade 22 (also referred to herein as “blade 22”) is employed to introduce the flaw in the end portion 20 of the optical fiber 10, as illustrated in FIG. 1. The blade 22 can be included in a cleaver to cleave an optical fiber, as will be discussed in examples described below. In this embodiment and as will be discussed by example in more detail below, one or more cleaving materials are imbedded into a carrier material to form the blade 22. In one example of such an imbedded carrier blade, the blade 22 in FIG. 1 is comprised of a carrier body 24 defining a blade edge 26. In this embodiment, the blade edge 26 comprises an essentially straight blade edge section 27. Manufacturing variances or tolerances may prevent a perfectly straight blade edge section 27. However, other types of blade edge sections 27 other than essentially straight are possible as well, including but not limited to an essentially arcuate edge section as will be discussed in more detail below with regard to the exemplary imbedded carrier blade in FIG. 3.

With continuing reference back to FIG. 1, at least one cleaving material 28 (also referred to as “cleaving material 28”) is imbedded into at least a portion of the carrier body 24. For example, the cleaving material 28 may be at least partially molded into the carrier body 24 during the molding of the blade 22. The cleaving material 28 is comprised of one or more materials, such as one or more hardened minerals for example, that are sufficient hard and capable of inducing a flaw in the glass of the optical fiber 10. In this embodiment, the cleaving material 28 is additionally exposed on at least a portion of the blade edge 26 of the blade 22. Thus, when the blade edge 26 of the blade 22 contacts the end portion 20 of the optical fiber 10, the blade edge 26 can induce a flaw in the end portion 20 of the optical fiber 10 contacted by the blade edge 26 for cleaving the optical fiber 10.

The cleaving material 28 may be selected from one or more materials that are capable of inducing a flaw in the glass of an optical fiber. For example, the cleaving material 28 may be a material that has a hardness greater than glass optical fiber. For example, the hardness of the cleaving material 28 may be at least a seven (7) Moh's hardness according to the Moh's hardness scale. Examples of materials that may be used singly or in combination with each other or other materials for the cleaving material 28 include, but are not limited to an aluminum-based compound such as aluminum oxide, diamond, titanium, a titanium-based compound, titanium oxide, carbide, silicon carbide, tungsten carbide, titanium carbide, a carbide derivative, and combinations thereof.

As the blade 22 in FIG. 1 is used repeatedly to cleave optical fibers, the carrier body 24 may wear. However, because the cleaving material 28 is disposed in at least a portion of the carrier body 24, as the blade edge 26 is worn due to use, the cleaving material 28 may be continued to be exposed at the blade edge 26. Thus, the blade edge 26 of the blade 22 may not require sharpening and/or re-sharpening thus reducing maintenance costs for the blade 22. The blade 22 can remain viable to be repeatedly used without being disposed, if desired. Further, by disposing the cleaving material 28 in at least a portion of the carrier body 24 so that the cleaving material 28 may continue to be exposed as the blade edge 26 wears, a material(s) may be selected for producing the carrier body 24 that does not have to be capable of being sharpened, although such is not required. A material that does not have to be capable of being sharpened may be less expensive than a material, such as a metal, that has to be capable of being resharpened.

With continuing reference to FIG. 1, the blade 22 is controlled to bring a portion of the cleaving material 28 imbedded in the carrier body 24 in contact with the end portion 20 of the optical fiber 10 to induce a flaw 30 in the end portion 20 of the optical fiber 10. The blade 22 may be controlled by human hand or a cleaving device, examples of which will be described below in this disclosure. The cleaving material 28 disposed in the blade 22 is brought into contact with the end portion 20 of the optical fiber 10 to induce the flaw 30 in the end portion 20 of the optical fiber 10 for cleaving the end portion 20 of the optical fiber 10. In the embodiment of FIG. 1, the optical fiber 10 is held in place while the blade edge 26 of the blade 22 is moved in a direction D₂ towards the end portion 20 of the optical fiber 10 to bring the cleaving material 28 in contact with the end portion 20 of the optical fiber 10. Alternatively, the blade 22 could be held in place and the end portion 20 of the optical fiber 10 moved to be brought into contact with the blade edge 26. In either case, relative movement is created between the end portion 20 of the optical fiber 10 and the cleaving material 28 exposed on the blade edge 26 to create the flaw 30. The blade 22 may be controlled in a swiping motion to cause the blade edge 26 to be swiped across the end portion 20 of the optical fiber 10 to induce the flaw 30 in the end portion 20 of the optical fiber 10 as an example. The flaw 30 cracks the end portion 20 of the optical fiber 10. The end face 18 can then be created in the end portion 20 of the optical fiber 10 by breaking the optical fiber 10 at the flaw 30. In this manner, the blade 22 is used to cleave the end portion 20 of the optical fiber 10.

Any coating (not shown) disposed on the outside of the end portion 20 of the optical fiber 10 is removed prior to placing the blade edge 26 of the blade 22 in contact with the end portion 20 of the optical fiber 10. This is so that the cleaving material 28 can directly contact glass (i.e., the cladding 14 and/or core 12 in FIG. 2) of the end portion 20 of the optical fiber 10. In this regard, any coating disposed around the core 12 and/or the cladding 14 may be removed prior to placing the blade edge 26 of the blade 22 in contact with the optical fiber 10.

Different configurations of the blade 22 are possible. For example, the carrier body 24 may be comprised of any type of one or more carrier materials 32 (hereinafter “carrier material 32”) desired. For example, the carrier material 32 may comprise one or more metal materials or one or more non-metal materials, or a combination thereof. The carrier material 32 can also be a single material or a composite of materials. The carrier material 32 can be selected based on the desired characteristics and cost of the material(s). As an example, providing a carrier material 32 comprised of a polymer or polymer-based material or materials may be desired. A polymer material is capable of being produced by a molding process, whereby the cleaving material 28 can be imbedded into the polymer during a non-solid phase. As an example, the cleaving material 28 may be infused or mixed into the polymer carrier material 32. Thereafter, as an example, the blade edge section 27 of the blade edge 26 can be molded from the mixed polymer carrier material 32 and cleaving material 28 within a mold to produce the carrier body 24 with the carrier material 28 imbedded in at least a portion of the carrier body 24. In this example, the mold defines the blade edge section 27 of the blade edge 26 with the cleaving material 28 exposed on at least a portion of the blade edge section 27.

In the example of the blade 22 in FIG. 1, the mold defines the blade edge section 27 as an essentially straight edge. Alternatively, as previously discussed and as will be discussed in FIG. 3 below, a mold could be provided to define another geometry of a blade edge section for a blade edge for an imbedded carrier blade, such as an essentially arcuate blade edge section. As illustrated in FIG. 1, the blade edge section 27 can be defined between two surfaces 34, 36 of the carrier body 24 each having longitudinal axes A₁, A₂, respectively, intersecting each other. The two surfaces 34, 36 could be disposed such that the longitudinal axes A₁, A₂ intersect at any angle Θ₁ to each other. For example, the angle Θ₁ in FIG. 1 may be between about fifty-five degrees (55°) and about sixty-five degrees (65°).

If the carrier material 32 is comprised of a polymer, any type of polymer may be employed. Non-limiting examples include nylon, a polyfenlene sufide (PPS), a polyethylene, a polypropylene, a polypropylene olefin (TPO), a thermoplastic polyester, a thermoplastic vulcanizate (TPV), a polyvinyl chloride (PVC), a chlorinated polyethylene, a styrene block copolymer, an ethylene methyl acrylate (EMA), an ethylene butyl acrylate (EBA), a polyurethane, silicone, an isoprene, a chloroprene, a neoprene, a melamine-formaldehyde, a polyester, and any combinations thereof. The carrier material 32 could also be comprised of at least one ceramic material if desired as well.

The carrier material 32 may be chosen so that the carrier body 24 is rigid when the blade 22 is formed. The embodiments herein, however, are not limited to a rigid carrier body. Providing a rigid carrier body 24 can provide longevity for the blade 22 and can ensure that the blade edge section 27 of the blade edge 26 is sufficiently rigid to score an optical fiber. If the carrier body 24 is too flexible, the flaw 30 induced in the optical fiber 10 may not be made precisely and may be larger than desired. As an example, the carrier material 32 for the carrier body 24 may be selected so that the carrier body 24 has a rigidity of at least thirty (30) Shore. As another example, the carrier material 32 for the carrier body 24 may be selected so that the carrier body 24 has a rigidity of at least one (1) GigaPascal (GPa) flexure modulus.

Further, the cleaving material 28 could be mixed with the carrier material 32 of the carrier body 24 in a manner that generally uniformly distributes the cleaving material 28 in the carrier body 24 when the blade 22 is formed. Alternatively, the cleaving material 28 could be mixed with the carrier material 32 of the carrier body 24 in a manner that generally non-uniformly distributes the cleaving material 28 in the carrier body 24 when the blade 22 is formed. The cleaving material 28 may be provided in the carrier material 32 such that the loading rate of the cleaving material 28 in the carrier body 24 is any loading rate desired. As a non-limiting example, the cleaving material 28 could be mixed in or otherwise disposed in the carrier material 32 of the carrier body 24 at a loading rate of between about fifty-five (55%) percent and eighty-five percent (85%) by weight as an example.

Further, to achieve the desired cleaving characteristics of the blade 22, the particle sizes of the cleaving material 28 mixed in or otherwise disposed in the carrier material 32 could be any particle size desired that is sufficient to score the optical fiber 10. As a non-limiting example, the particle sizes of the cleaving material 28 may be between about five micrometers (5 μm) and about forty-five (45) micrometers (45 μm). In one embodiment, the carrier material 32 comprises Nylon 6-6, wherein the cleaving material 28 comprises an aluminum oxide and is disposed in the carrier body 24 at a loading rate of between about fifty-five percent (55%) and about eighty-five percent (85%) in particle sizes between about ten micrometers (10 μm) and about twenty micrometers (20 μm).

FIG. 3 is an exemplary imbedded carrier blade 22′ employing an arcuate blade edge section 41 and an exemplary method for cleaving an optical fiber by creating a flaw in a portion of the optical fiber using the imbedded carrier blade. Components illustrated in FIG. 3 that are common to the components in FIG. 1 are provided in FIG. 3 with common element numbers and will not be re-described. In the blade 22′ of FIG. 3, the blade edge section 41 of the blade edge 26 is an arcuate blade section. Further, the carrier body 24 includes a core material 42 disposed therein to provide further support or rigidity to the blade 22′. For example, the core material 42 may comprise a metal material. The carrier material 32 of the carrier body 24 imbedded with the cleaving material 28 may be disposed around the core material 42 during molding or manufacturing of the blade 22′. Alternatively, where the core material 42 is shown in FIG. 3, an internal chamber could be disposed or left in the carrier body 24, such as to reduce the amount of carrier material 32 disposed in the carrier body 24, such as to save material costs.

With reference to FIGS. 1 and 3, during the cleaving process, the end portion 20 of the optical fiber 10 may be placed under stress after placing the blade edge 26 of the blade 22 in contact with the end portion 20 of the optical fiber 10 to cleave the end portion 20 of the optical fiber 10. Placing the end portion 20 of the optical fiber 10 under stress can propagate the flaw 30 induced in the end portion 20 of the optical fiber 10 by the blade edge 26 of the blade 22, 22′ to cleave the end portion 20 of the optical fiber 10. Alternatively, the end portion 20 of the optical fiber 10 may be placed under stress before placing the blade edge 26 in the blade 22, 22′ in contact with the end portion 20 of the optical fiber 10 to cleave the end portion 20 of the optical fiber 10. Placing the end portion 20 of the optical fiber 10 under stress prior to inducing the flaw 30 in the optical fiber 10 with the blade 22, 22′ can also propagate the induced flaw 30 to cleave the end portion 20 of the optical fiber 10. Examples of placing the end portion 20 of the optical fiber 10 under stress includes but is not limited to placing a tension on the end portion 20 of the optical fiber 10, rotating or twisting the end portion 20 of the optical fiber 10, or bending the end portion 20 of the optical fiber 10.

For example, the end portion 20 of the optical fiber 10 in FIG. 1 is placed under tension after the blade edge 26 of the blade 22 is placed into contact with the end portion 20 of the optical fiber 10 to score the end portion 20 of the optical fiber 10. As illustrated in FIG. 1, portions 38A and 38B of the optical fiber 10 disposed on each side of the end portion 20 of the optical fiber 10 where the flaw 30 is desired to be induced are clamped by clamps 40A, 40B. The clamps 40A, 40B with the portions 38A, 38B of the end portion 20 of the optical fiber 10 secured therein may be pulled away from each other in directions D₃ and D₄ to place the end portion 20 of the optical fiber 10 under tension. The tension will cause the end portion 20 of the optical fiber 10 to break about the flaw 30 to create the end face 18. If the end portion 20 of the optical fiber 10 is not placed under a stress before the flaw 30 is introduced by the blade edge 26 of the blade 22, a stress could be subsequently placed on the end portion 20 of the optical fiber 10 to create the break about the flaw 30 to create the end face 18.

It may also be desirable to bend the end portion 20 of the optical fiber 10 in addition to placing the end portion 20 of the optical fiber 10 under a tension or other stress prior to inducing the flaw 30 with the blade 22. Placing a bend in the end portion 20 of the optical fiber 10 can assist in propagating the flaw 30 into a break in the end portion 20 of the optical fiber 10 to create the end face 18. Placing a bend in the end portion 20 of the optical fiber 10 creates tension on the outside surface of a bent portion of the end portion 20 of the optical fiber 10, which assists in propagating the flaw 30 into a break in the end portion 20 of the optical fiber 10.

After the end portion 20 of the optical fiber 10 is broken at the flaw 30, the end face 18 is created, as illustrated by example in FIG. 2. The end face 18 illustrated in FIG. 2 is disposed in the end portion 20 of the optical fiber 10 in a cross-sectional plane P₁ orthogonal or substantially orthogonal to a longitudinal axis A₃ of the optical fiber 10. However, the blade 22, 22′ could also be used to provide an angle-cleaved end face in the end portion 20 of the optical fiber 10, if desired. For example, the end portion 20 of the optical fiber 10 could be rotated during the introduction of the flaw 30 with the blade 22, 22′ to affect the angle of the end face 18 created in the end portion 20 of the optical fiber 10. The apex of the bend disposed in the end portion 20 of the optical fiber 10 when the blade 22, 22′ is used to induce the flaw 30 can also affect the angle of the end face 18 created in the end portion 20 of the optical fiber 10. Methods of creating an angled end face using a cleaver blade can be used to create an angled end face using the blade 22, 22′.

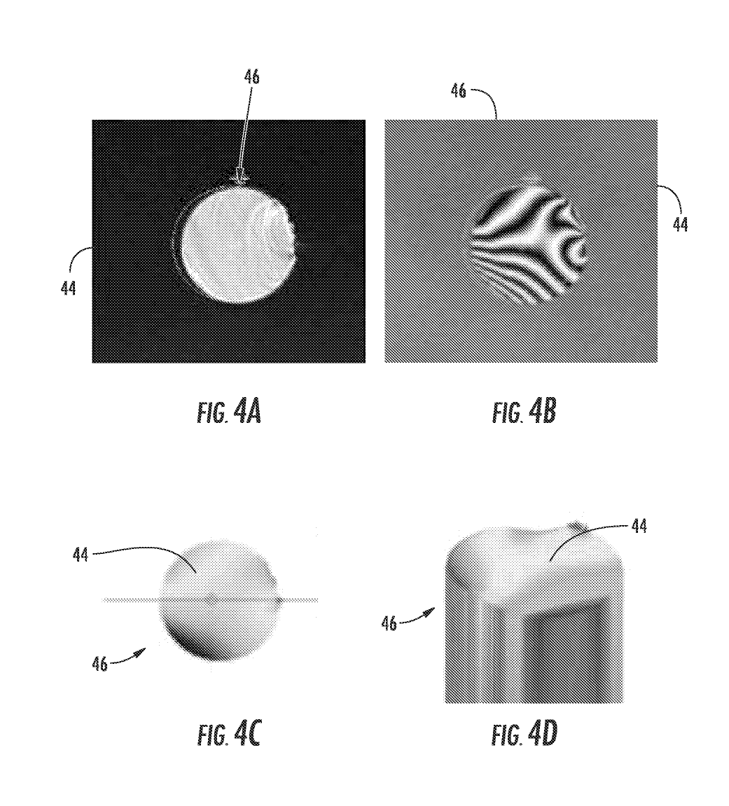

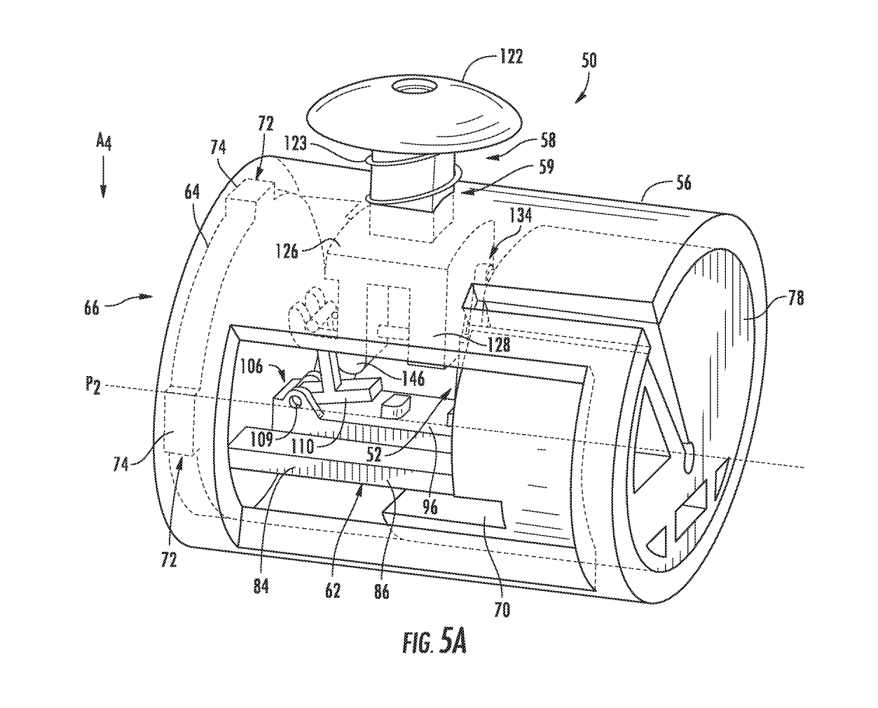

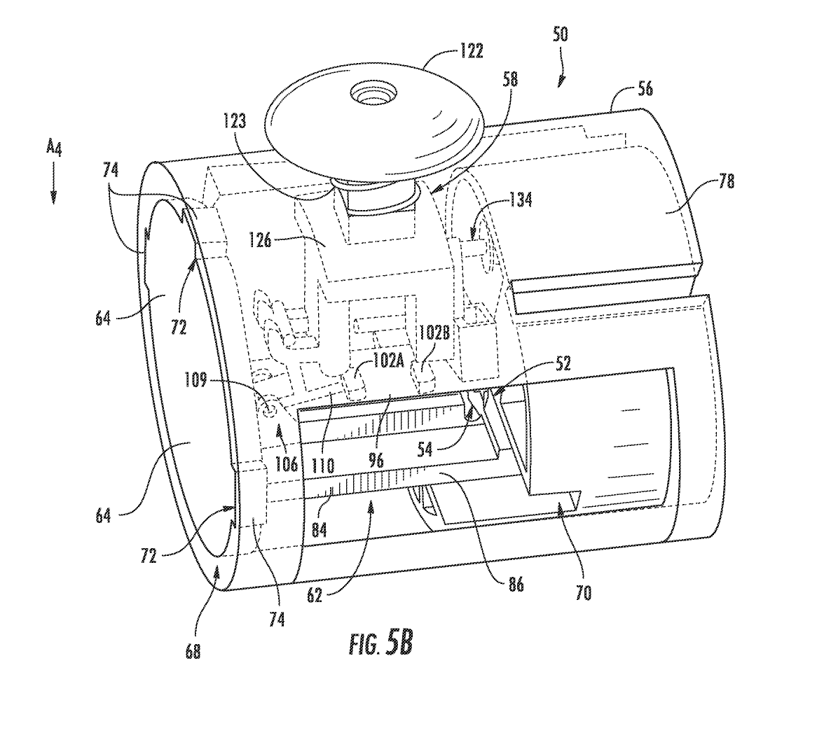

FIGS. 4A-4D provide images of an end face of an optical fiber cleaved using an imbedded carrier blade, such as the blades 22, 22′ described above, employing a cleaving material of aluminum oxide disposed in a carrier body of Nylon 6-6 polymer at an approximate loading rate of eighty percent (80%) to show the quality of the surface of the end face possible with this exemplary imbedded carrier blade arrangement. In this regard, FIG. 4A is a camera image of an end face 44 of an optical fiber 46 cleaved using the imbedded carrier blade to illustrate an exemplary quality of the surface of the end face 44. FIG. 4B is an image of an interference pattern of interference generated by an interferometer captured at the focal plane of an imaging device from the end face 44 of the cleaved optical fiber 46 in FIG. 4A to illustrate the quality of the surface of the end face 44. FIG. 4C is a surface topography map of the end face 44 of the cleaved optical fiber 46 in FIG. 4A to illustrate the quality of the surface of the end face 44. FIG. 4D is a perspective view of the end face 44 of the cleaved optical fiber 46 in FIG. 4A to illustrate the quality of the surface of the end face 44.

With continuing reference to FIGS. 4A-4D, the resulting cleave angle of the end face 44 achieved after one cleaving was approximately 0.685 degrees in this example. A number of cleave tests were performed using the imbedded carrier blade in an exemplary test. The exemplary test provided a maximum cleave angle of 1.500 degrees, and a minimum cleave angle of 0.385 degrees, with a mean cleave angle of 0.788 degrees having a standard deviation of 0.366 degrees. For comparison purposes only, a machined carbide blade also provided similar results in an exemplary test using essentially the same conditions as the preceding test. Those results produced a maximum cleave angle of 1.458 degrees, and a minimum cleave angle of 0.592 degrees, with a mean cleave angle of 0.804 degrees having a standard deviation of 0.254 degrees.

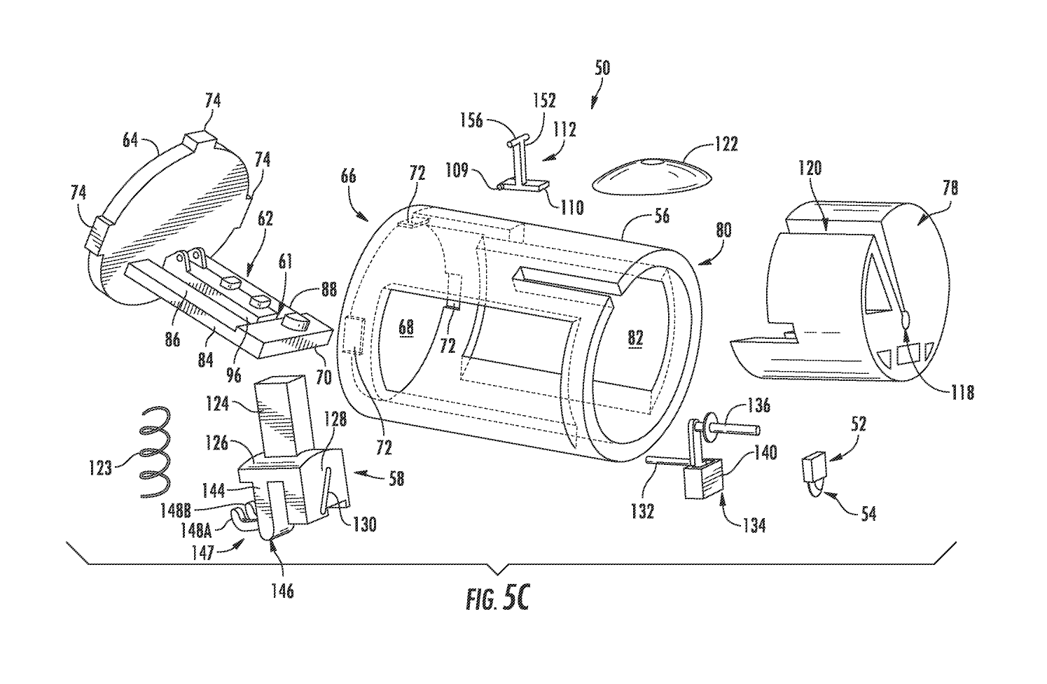

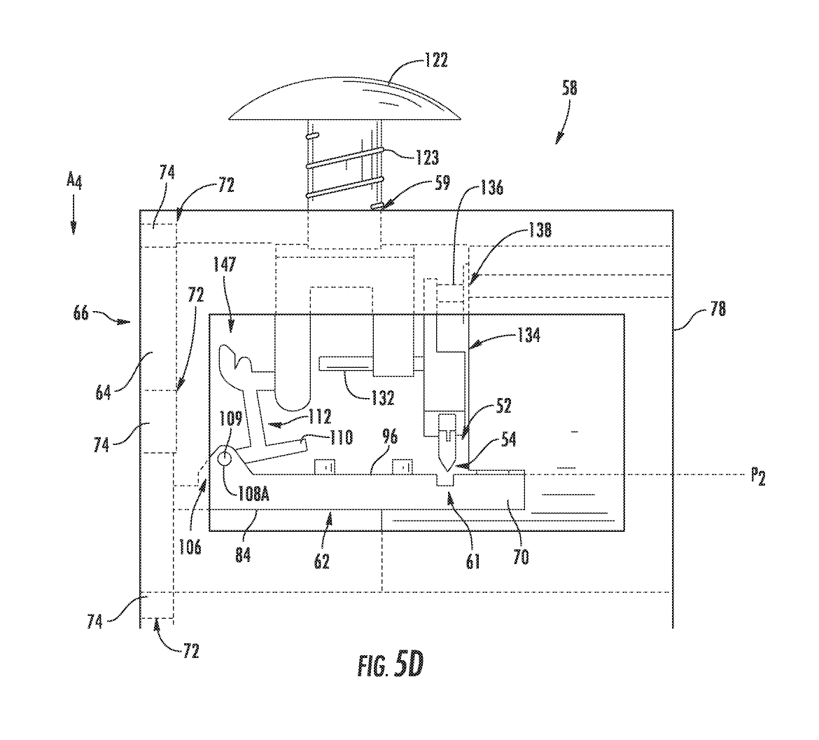

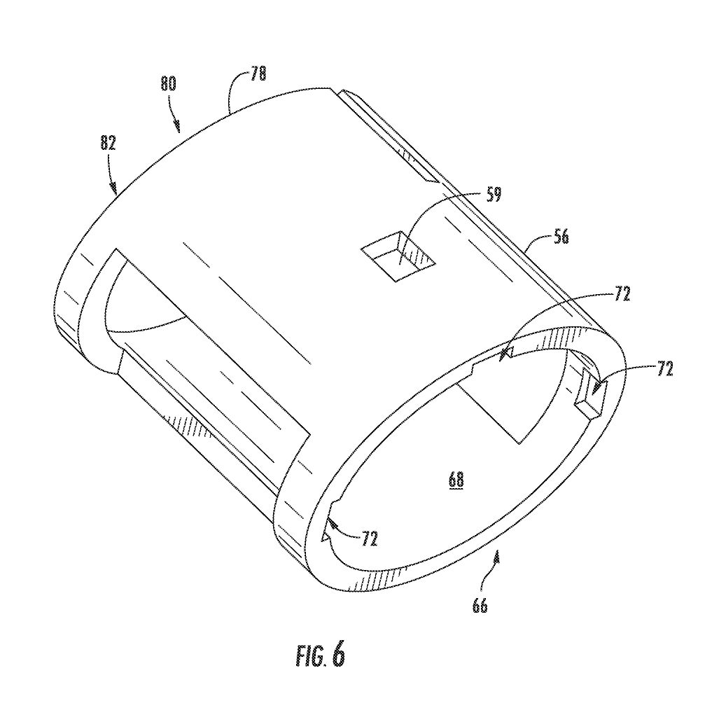

The remainder of this disclosure in FIGS. 5A-14B includes exemplary cleavers and related methods that can employ an imbedded carrier blade, including the blades 22, 22′ and exemplary test blades described above, to induce a flaw in an end portion of an optical fiber for cleaving the optical fiber. The methods and principles discussed above and with respect to FIGS. 1-3 may be employed in these cleavers and related components and methods. The cleaver and related components and methods described below with regard to FIGS. 5-14B are not limited to the use of a cleaving blade that is an imbedded carrier blade, including the imbedded carrier blades described with regard to FIGS. 1-4.

FIGS. 5A-13 provide a first exemplary cleaver that can be used to cleave an optical fiber. In this regard, FIG. 5A is a right perspective view of an exemplary cleaver 50 and showing internal components of the cleaver 50. FIG. 5B is a left perspective view of the exemplary cleaver 50 in FIG. 5A and showing internal components of the cleaver 50. FIG. 5C is an exploded view of the cleaver 50 in FIG. 5A. FIG. 5D is a front view of the cleaver 50 in FIG. 5A and showing internal components of the cleaver 50. As will be discussed in more detail below with regard to FIGS. 5A-13, the cleaver 50 is designed to allow a technician to dispose an end portion of an optical fiber to be cleaved in the cleaver 50 and to cleave the end portion of the optical fiber to provide an end face in the end portion of the optical fiber. As will be discussed below in more detail, the cleaver 50 is configured to actuate a supported blade 52 (FIGS. 5B-5D), including but not limited to an imbedded carrier blade such as those described above as examples, in an at least partially arcuate cleaving path to cleave an optical fiber disposed in an optical fiber path in the cleaver 50. The optical fiber path disposed in the cleaver 50 intersects the at least partially arcuate cleaving path. In this manner, the cleaver 50 is configured to direct a blade edge 54 in the blade 52 in an arcuate and swiping motion to contact an end portion of an optical fiber to induce a flaw in the optical fiber to cleave the optical fiber.

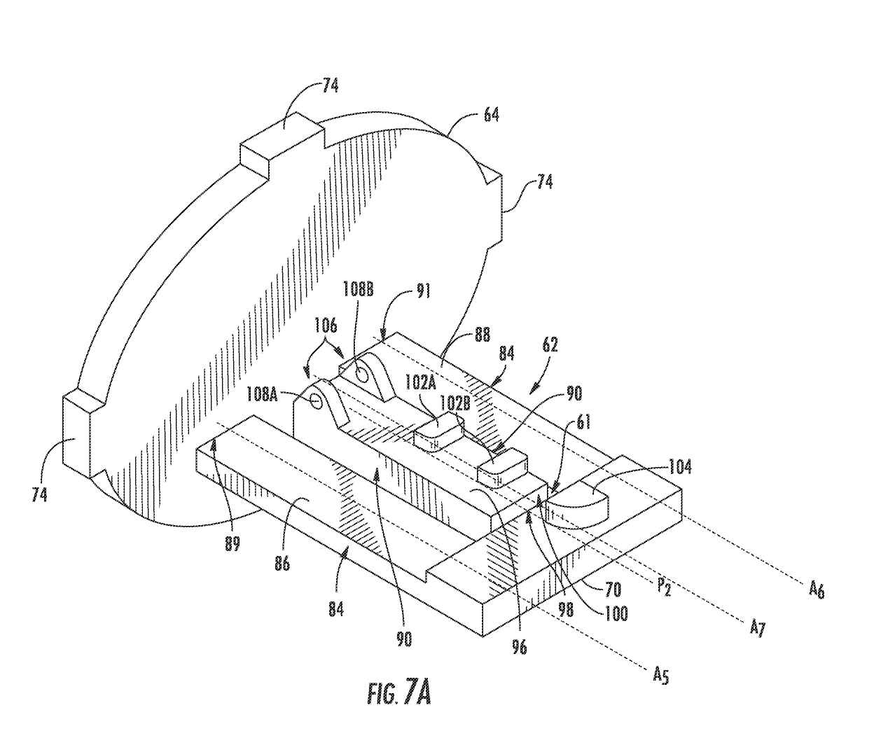

The cleaver 50 in this embodiment is comprised of a body 56. A rear perspective view of the body 56 is also illustrated in FIG. 6. The body 56 may be constructed out of any material desired. In this embodiment, the body 56 was molded from a polymer-based material. The body 56 is configured to support a number of components that are provided in the cleaver 50 and discussed below to provide for cleaving an end portion of an optical fiber. The cleaver 50 includes an actuator 58 that is disposed in an actuator opening 59 in the body 56 (FIG. 6) and configured to be actuated along an actuation path A₄, as illustrated in FIGS. 5A and 5D. When the actuator 58 is actuated, the blade 52 supported by the actuator 58 is moved in an at least partially arcuate cleaving path to contact an end portion of an optical fiber disposed in an optical fiber path P₂ in the body 56 disposed across a cleaving channel 61 illustrated in FIGS. 5C and 5D, and as will be described below in more detail. More information and details on the actuator 58 will be described below.

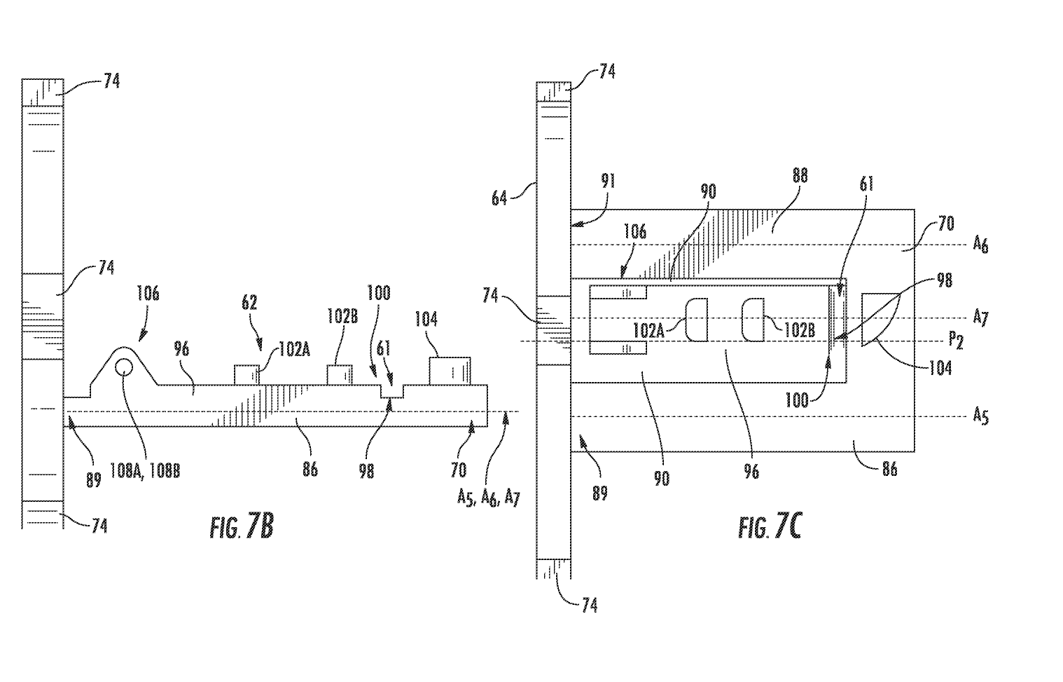

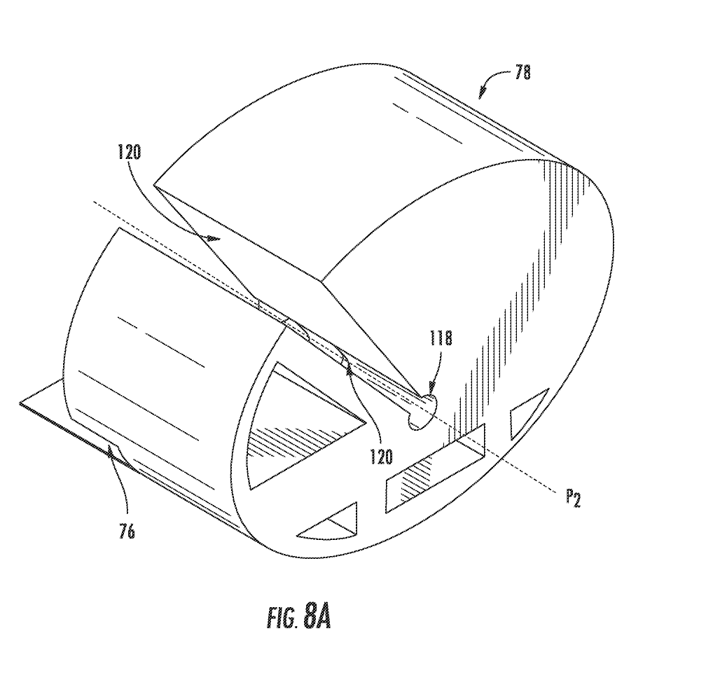

With continuing reference to FIGS. 5A-5D, the optical fiber path P₂ in the body 56 is disposed along a cleaving stage platform 62. The cleaving stage platform 62 provides a platform to support an end portion of an optical fiber to provide for the end portion of the optical fiber to be cleaved when the actuator 58 is actuated, causing the blade 52 to swipe across the end portion of the optical fiber when disposed across the cleaving channel 61. In this embodiment, the cleaving stage platform 62 is attached or provided as an integral part of a left-side end cap 64, and also as illustrated in the right side perspective, front, and top views of the cleaving stage platform 62 in FIGS. 7A-7C, respectively. A left side 66 of the body 56 contains a left side opening 68, as illustrated in FIGS. 5B, 5C and 6, configured to receive the left-side end cap 64, illustrated in FIGS. 5A-5D and 7A-7C.

When disposing the left side end cap 64 into the left side opening 68 of the body 56 as illustrated in FIGS. 5B and 5D, a bridge member 70 of the cleaving stage platform 62 is first disposed through the left side opening 68, and the cleaving stage platform 62 continues to be inserted until the left-side end cap 64 is secured to the left side 66 of the body 56. The left side 66 of the body 56 includes recesses 72, as illustrated in FIG. 5B, that are configured to receive protrusions 74 disposed in the left-side end cap 64, as illustrated in FIGS. 5A-5D and 7A-7C. The protrusions 74 rest inside the recesses 72 for the body 56 in a friction fit to support the left-side end cap 64, thus supporting the cleaving stage platform 62 in the body 56. The recesses 72 also serve to force proper alignment of the left-side end cap 64 when inserted into the left side opening 68 of the body 56 so that the cleaving stage platform 62 is properly aligned when inserted and disposed in the body 56. The left-side end cap 64 may be constructed out of any material desired, and is constructed out of a polymer-based material in this example.

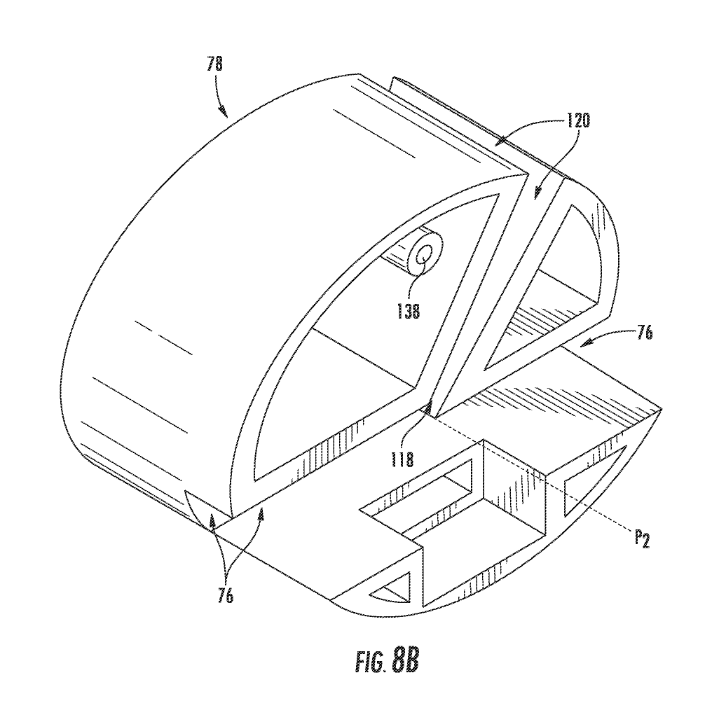

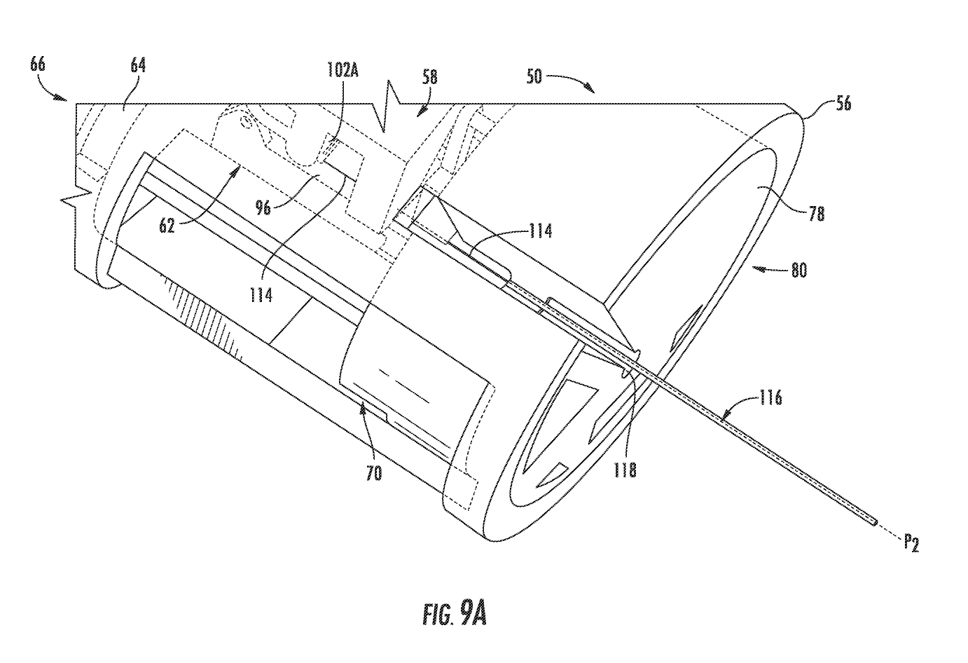

To support the bridge member 70 of the cleaving stage platform 62, a recess 76 is disposed in a right-side end cap 78, as illustrated in FIGS. 5A and 5D and the right side and left side perspective views of the right-side end cap 78 in FIGS. 8A and 8B, respectively. The recess 76 disposed in the right-side end cap 78 is configured to receive and support the bridge member 70 of the cleaving stage platform 62 to prevent the cleaving stage platform 62 from moving inside the body 56 causing the left-side end cap 64 to act as a pivot. The cleaving stage platform 62 should be secured in the body 56 with a goal of no relative movement about the body 56 to maintain the optical fiber path P₂ and cleaving path 61 in essentially fixed relation to the arcuate cleaving path of the blade 52, as illustrated in FIG. 5D. To support the right-side end cap 78 in the body 56 of the cleaver 50, a right side 80 of the body 56 contains a right side opening 82, as illustrated in FIGS. 5C and 6, configured to receive the right-side end cap 78 in a friction fit. The right-side end cap 78 may be constructed out of any material desired, and is constructed out of a polymer-based material in this example.

More detail will now be discussed with regard to the cleaving stage platform 62 provided to support an end portion of an optical fiber inside the body 56 of the cleaver 50 to be cleaved with regard to FIGS. 7A-7C. As illustrated therein, the cleaving stage platform 62 in this embodiment includes a support platform 84. The support platform 84 includes a first member 86 disposed along a first axis A₅. In this embodiment, the first member 86 is an elongated member disposed along the first axis A₅, which is a longitudinal axis in this embodiment. The support platform 84 also includes a second member 88 disposed along a second axis A₆. In this embodiment, the second member 88 is an elongated member disposed along the second axis A₆, which is also a longitudinal axis in this embodiment. Ends 89, 91 of the first and second members 86, 88, respectively, are attached or integral to the left-side end cap 64 so that the support platform 84 is supported by the body 56 when the left-side end cap 64 is secured in the left side opening 68 of the body 52, as previously discussed with regard to FIGS. 5A-5D and 6. An opening 90 is disposed between the first member 86 and the second member 88. The bridge member 70 is connected to first ends 92, 94 of the first member 86 and the second member 88, respectively. The bridge member 70 may be provided as a separate component from the first and second members 86, 88, or may be provided as an integral with the first and second members 86, 88.

With continuing reference to FIGS. 7A-7C, a clamping platform 96 is provided. The clamping platform 96 is disposed along a third axis A₇ in the opening 90. A living hinge 98 is disposed between the bridge member 70 and a first end 100 of the clamp platform 96 such that the clamp platform 96 is resiliently deflectable and movable relative to the bridge member 70 inside the opening 90 when a clamping force is applied to the clamp platform 96. As will be discussed in more detail below, actuation of the actuator 58 (FIGS. 5A-5D) will cause a clamping force to be applied to the clamping platform 96 to clamp an end portion of an optical fiber disposed in the optical fiber path P2 provided in the clamping platform 96 after the blade edge 54 contacts the end portion of the optical fiber at the cleaving channel 61. In this embodiment, the cleaving channel 61 is provided as the void in material of the clamp platform 96 to form the living hinge 98. As will be discussed in more detail below, the actuator 58 is configured to support both the blade 52 and a clamping member that are both moved when the actuator 58 is actuated to cleave and clamp and end portion of an optical fiber during one actuation of the actuator 58.

With continuing reference to FIGS. 7A-7C, to support an end portion of an optical fiber disposed in the optical fiber path P2 to be cleaved in a lateral direction, optional fiber stops 102A, 102B are disposed in the clamping platform 96. The fiber stops 102A, 102B are disposed adjacent the optical fiber path P₂ so that an end portion of an optical fiber disposed in the optical fiber path P₂ rests adjacent to the fiber stops 102A, 102B. Similarly, an optional fiber stop 104 is also disposed in the bridge member 70 and is also disposed adjacent to the optical fiber path P₂ and aligned with the fiber stops 102A, 102B in the same regards. Thus, when the blade edge 54 of the blade 52 passes back through the cleaving chamber 61 on the backstroke of the blade edge 54 during the release of the actuator 58 after actuation, as will be discussed in more detail below, the fiber stops 102A, 102B, 104 prevent an end portion of the optical fiber disposed in the optical fiber path P₂ from moving laterally beyond the fiber stops 102A, 102B, 104.

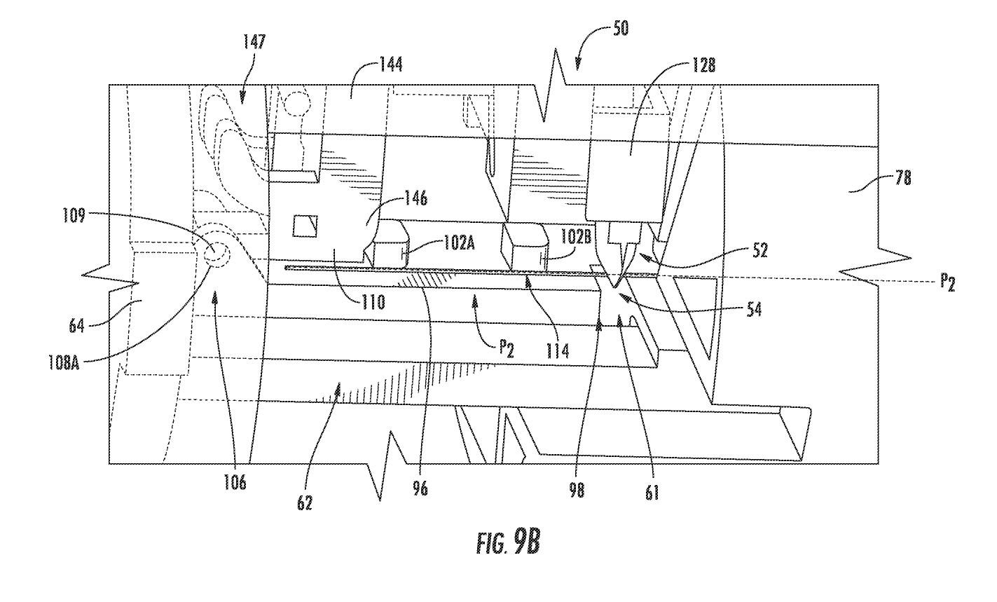

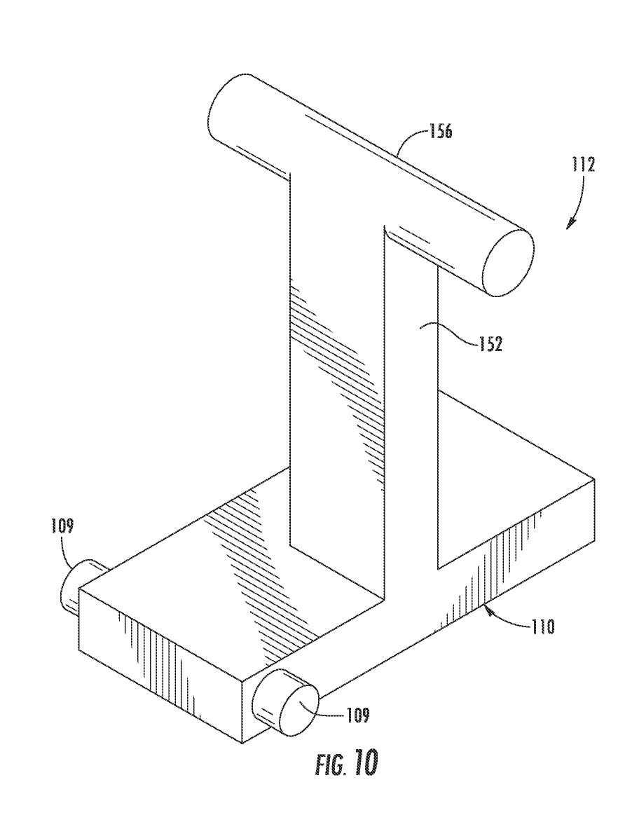

FIGS. 9A and 9B illustrate more detail of an end portion of an optical fiber inserted and disposed in the optical fiber path P₂ adjacent the fiber stops 102A, 102B, 104 disposed in the cleaving stage platform 62 of the cleaver 50 for cleaving the end portion of the optical fiber. FIG. 9A is a left side perspective view of the cleaver 50 in FIGS. 5A-5D with an end portion 114 of an optical fiber 116 disposed in the body 56 and disposed in the optical fiber path P₂ for cleaving. FIG. 9B is a side close-up view of the cleaver 50 in FIGS. 5A-5D with the actuator 58 actuated to move the blade edge 54 of the blade 52 in an at least partially arcuate cleaving path across the cleaving channel 61 and in contact with the end portion 114 of the optical fiber 116.

With reference to FIGS. 7A-7C and 9B, a hinge receiver 106 is disposed in the clamping platform 96. As will be discussed in more detail below, the hinge receiver 106 includes pin openings 108A, 108B (FIGS. 7A and 7B) configured to receive a pin 109 of a fiber clamp 110 of a fiber clamping mechanism 112 disposed in and actuatable by the actuator 58, as illustrated in FIGS. 5A-5D and FIG. 10. The fiber clamp 110 is configured to clamp an end portion of an optical fiber disposed in the optical fiber path P₂ to the clamping platform 96. The clamping force creates a stress in a flaw induced in the end portion of the optical fiber by the blade edge 52 of the blade 54 (FIGS. 5A-5D) to break the end portion of the optical fiber and create an end face in the end portion of the optical fiber.

In this regard, as illustrated in FIGS. 8A, 8B, and 9, the right-side end cap 78 includes a fiber receiver 118. The fiber receiver 118 is an opening that is configured to receive the end portion 114 of the optical fiber 116 and align the end portion 114 along the optical fiber path P₂ in the cleaving stage platform 62. The fiber receiver 118 is coupled to a fiber slot 120 disposed through the right-side end cap 78 so that the end portion 114 of the optical fiber 116 can easily be disposed therethrough and into the fiber receiver 118. After stripping the end portion 114 of the optical fiber 116 to expose glass, the end portion 114 of the optical fiber 116 is disposed in the fiber receiver 118 and inserted in the optical fiber path P₂ and can be pushed forward until the end portion 114 abuts the left-side end cap 64 adjacent the fiber stops 102A, 102B, 104, as illustrated in FIG. 9B.

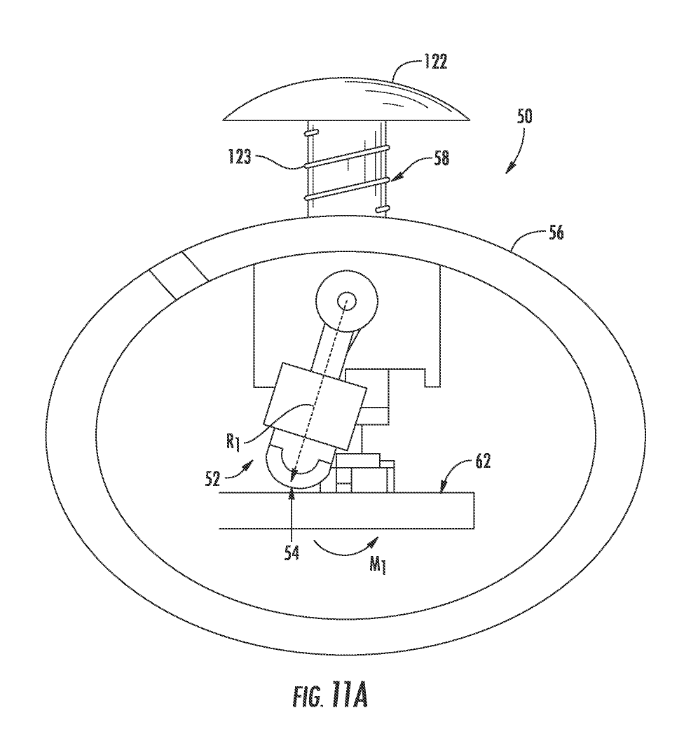

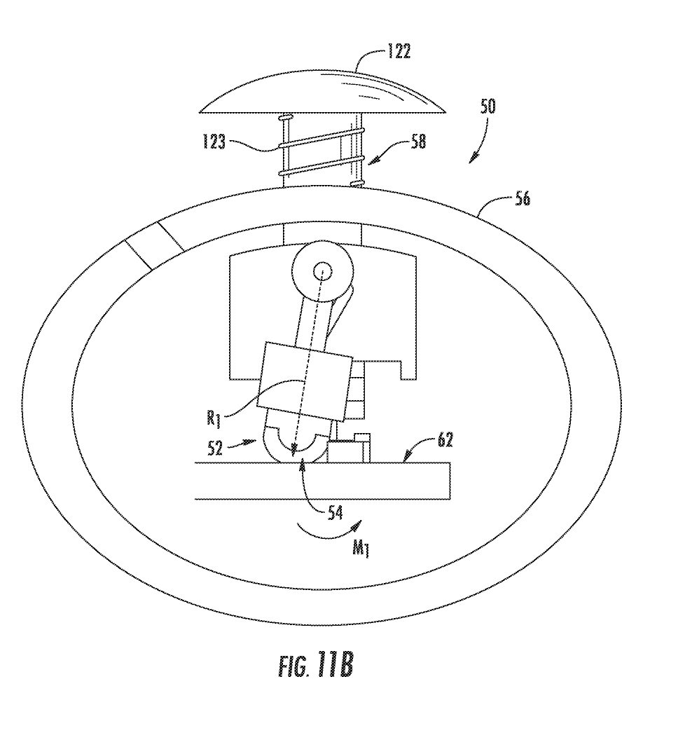

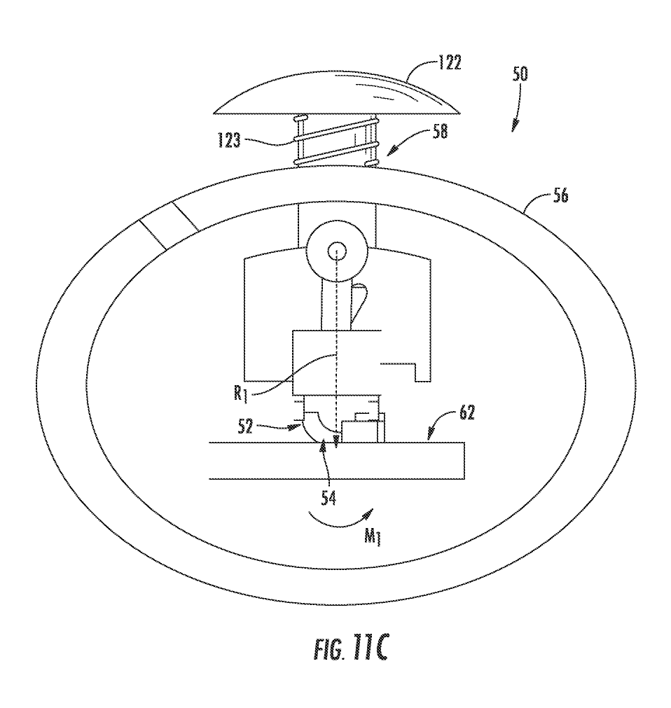

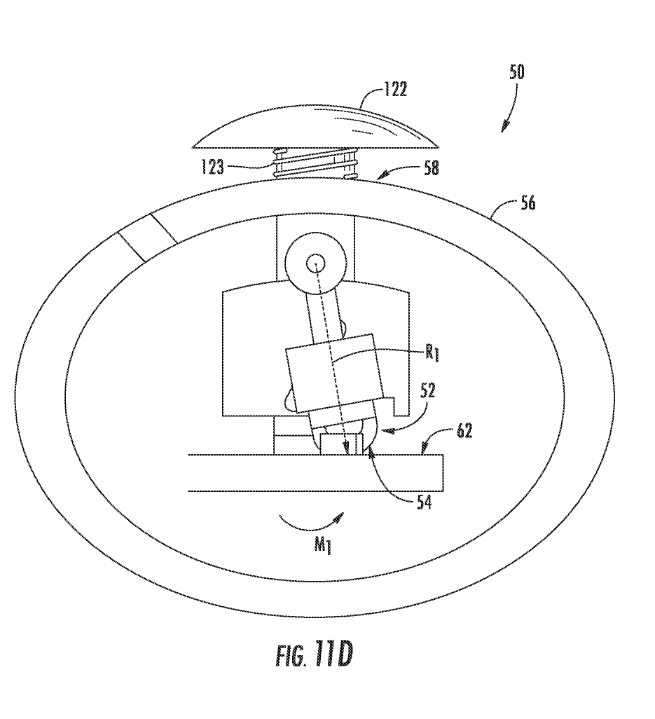

The arcuate motion of the blade 52 controlled by the actuator 58 will now be described. FIG. 11A is a right side view of the cleaver 50 in FIGS. 5A-5D with the right-side end cap 78 removed to show the position of the blade 52 and blade edge 54 when the actuator 58 is not actuated. As illustrated in FIG. 11A, a radius R₁ defines the radius of the arcuate path of an arcuate motion M₁ of the blade edge 54 in the cleaver 50 as the actuator 58 is actuated. As illustrated in FIG. 11B, when the actuator 58 is begun to be actuated in the arcuate motion M₁, the actuator 58 will begin to move the blade 52 in an arcuate path to eventually pass the blade edge 54 through the cleaving channel 61 and intersect with the optical fiber path P₂ disposed in the body 56 to score the end portion 114 of the optical fiber 116 (FIG. 9B). As illustrated in FIG. 11C and also in FIG. 9B, with the actuator 58 further actuated from the actuation position in FIG. 11B, the blade edge 54 of the blade 52 continues in the arcuate motion M1 passing through the cleaving channel 61 and intersecting with the optical fiber path P₂ disposed in the body 56 to score the end portion 114 of the optical fiber 116. The blade edge 54 of the blade 52 is caused to be swiped through the cleaving channel 61 to contact and score the end portion 114 of the optical fiber 116 as illustrated in FIG. 9B.

Thereafter, as the actuator 58 is further actuated, as illustrated in FIG. 11D, the actutator 58 causes the fiber clamp 110 to apply a clamping force to clamp the end portion 114 of the optical fiber 116 against the clamping platform 96 to break the end portion 114 of the optical fiber 116 scored by the blade edge 54 of the blade 52 above the cleaving channel 61. As illustrated in FIG. 11D, with the actuator 58 further actuated beyond the actuation position in FIG. 11C, the blade edge 54 of the blade 52 continues in the arcuate motion M1 causing the blade 52 to move beyond the cleaving channel 61.

As illustrated in FIG. 11E, when the actuator 58 is fully actuated, the blade edge 54 of the blade 52 continues in the arcuate motion M₁ to move the blade edge 54 to a fully articulated position. As the actuator 58 is released from the position of the actuator 58 in FIG. 11E, the blade edge 54 of the blade 52 retraces the arcuate motion M₁ as shown in FIGS. 11D, FIG. 11C re-swiping the blade edge 54 across the end portion 114 of the optical fiber 116 over the cleaving channel 61, and then FIG. 11B and eventually returning to the position in FIG. 11A when the actuator 58 is not actuated. When the actuator 58 is released, as will be discussed in more detail below, the fiber clamp 110 is raised from the clamping platform 96, as illustrated in FIG. 5A with the blade 52 then crossing back over the cleaving channel 61 in an arcuate cleaving path when the blade edge 54 is eventually cleared across the cleaving channel 61 and back to an unactuated position.

With reference back to FIGS. 5A-5D, the components of the actuator 58 are shown. The actuator 58 includes features that cause the blade edge 54 of the blade 52 to move in an arcuate motion as illustrated in FIGS. 11A-11E, and move the fiber clamp 110 in the fiber clamping mechanism 112 to clamp the end portion 114 of the optical fiber 116 disposed in the cleaver 50. Details regarding the features of the actuator 58 that cause both the blade edge 54 of the blade 52 to move in an arcuate motion as illustrated in FIGS. 11A-11E, and cause the fiber clamp 110 in the fiber clamping mechanism 112 to clamp the end portion 114 of the optical fiber 116 disposed in the cleaver 50, will now be described referring to FIGS. 5A-5D, 8B, 10 and 12A-13.

First, the arcuate motion of the blade 52 when the actuator 58 is actuated as illustrated in FIGS. 11A-11E will be described. As illustrated in FIGS. 5A-5D, the actuator 58 includes a cap 122 that is disposed on a shaft 124. The cap 122 provides a surface for a technician to push down on the shaft 124 to actuate the actuator 58. A spring 123 is disposed over the shaft 124 that extends outside the body 56 of the cleaver 50 to spring bias the shaft 124 upward away from the body 56. Thus, when a force is not applied to the cap 122 to actuate the actuator 58, the spring 123 will release stored energy to push the cap 122 away from the body 52 to move the shaft 124 upward towards the cap 122.

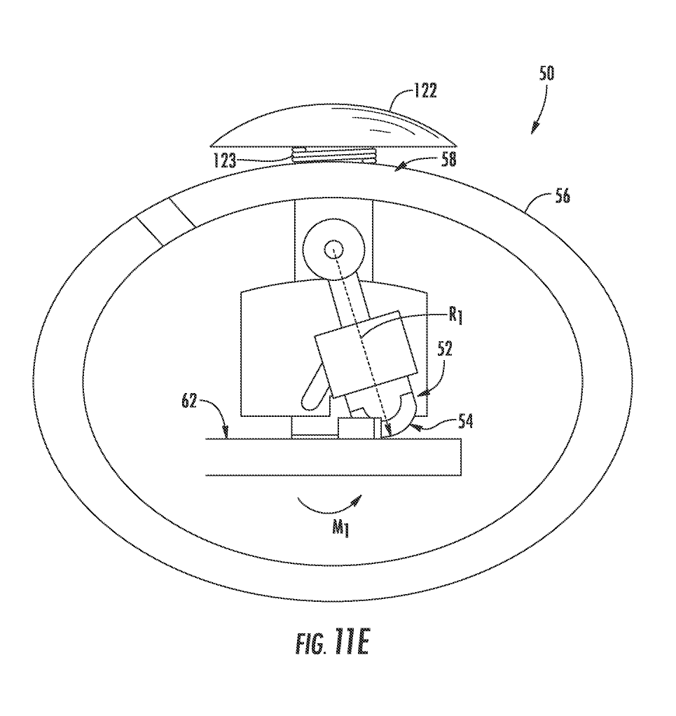

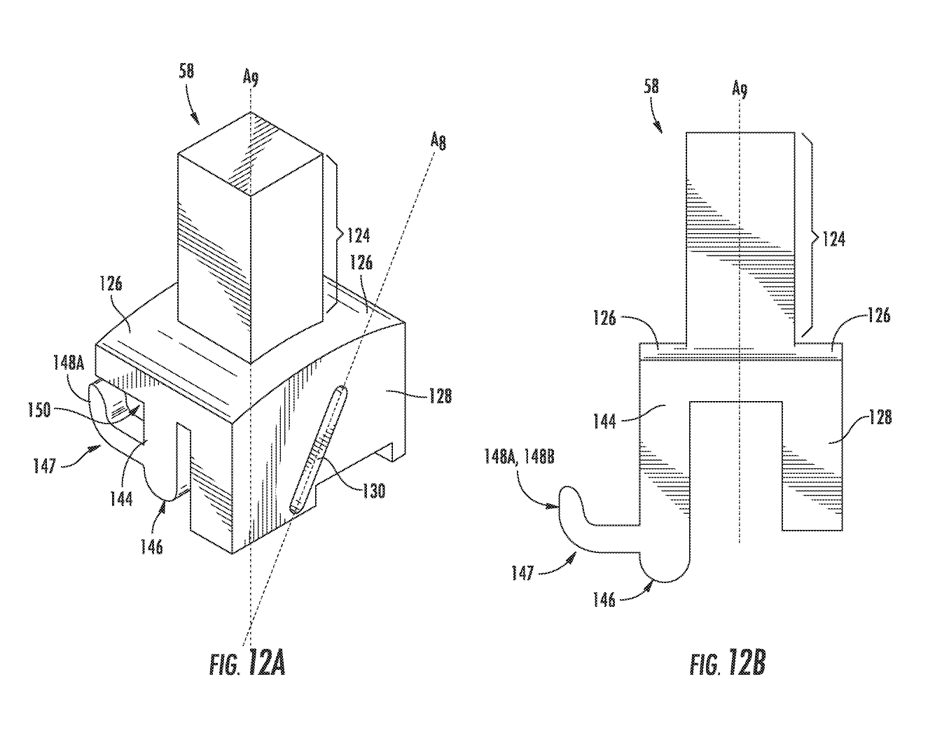

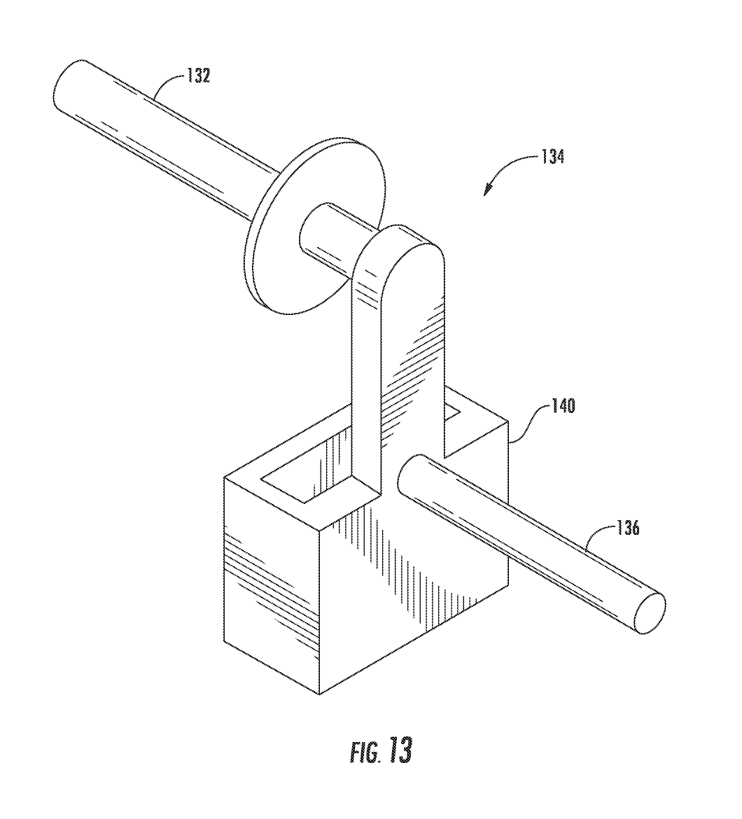

In this embodiment and as further illustrated in the perspective and front views of the actuator 58 in FIGS. 12A and 12B, the shaft 124 of the actuator 58 is connected to a yoke 126. The yoke 126 supports a blade arm extension member 128. The blade arm extension member 128 includes a slot 130 that receives an articulating pin 132 disposed in a blade arm 134, as illustrated in FIGS. 5C, 5D, and 13. The blade arm 134 is also supported by a pivot pin 136 provided therein disposed in a pivot opening 138 in the right-side end cap 78, as illustrated in FIGS. 5D and 8B. Thus, the blade arm 134 is supported between the pivot opening 138 in the right-side end cap 78 and the slot 130. The pivot pin 136 cannot traverse in the pivot opening 138, but the articulating pin 132 can traverse in the slot 130. Thus, as the shaft 124 and the blade arm extension member 128 are actuated, the articulating pin 132 is forced to traverse in the slot 130 since the pivot pin 136 is attached to the pivot opening 138 in the right-side end cap 78. The pivot pin 136 rotates inside the pivot opening 138. Because a longitudinal axis A₈ of the slot 130 intersects a longitudinal axis A₉ of the shaft, as illustrated in FIG. 12A, the blade arm 134 will move in the arcuate motion M₁ with regard to the longitudinal axis A₉ about the pivot opening 138 and pivot pin 136 when the actuator 58 is actuated, as illustrated in FIGS. 11A-11E described above. Thus, the blade 52 being disposed in a blade housing 140 attached to the blade arm 134, as illustrated in FIG. 5C, will also move in the arcuate motion M1 about the pivot opening 138 and pivot pin 136.

The actuator 58 in FIGS. 12A and 12B is also configured to apply a force to the fiber clamp 110 in the fiber clamping mechanism 112 in FIG. 10 to clamp the end portion 114 of the optical fiber 116 disposed in the cleaver 50, as previously discussed and illustrated in FIGS. 5A-5D and 9B. In this regard, as illustrated in FIGS. 12A and 12B, a clamp extension member 144 is also attached to the yoke 126 of the actuator 58. Thus, as the actuator 58 is actuated, the yoke 126 forces the clamp extension member 144 downward towards the cleaving stage platform 62. In this instance, an end portion 146 of the clamp extension member 144 moves downward toward the cleaving stage platform 62, eventually applying a force onto the fiber clamp 110. The force applied by the end portion 146 to the fiber clamp 110 will eventually cause the fiber clamp 110 to abut the clamping platform 96 and to clamp the end portion 114 of the optical fiber 116, as illustrated in FIG. 9B.

As illustrated in FIGS. 5C, 5D, 9B, 12A and 12B, a retention member in the form of a cradle member 147 in this embodiment is disposed in the clamp extension member 144. The cradle member 147 is designed to support and keep the movable fiber clamp 110 raised from the cleaving stage platform 62 when the actuator 58 is not actuated, as illustrated in FIG. 5D. The cradle member 147 is comprised of two members 148A, 148B with an opening 150 disposed therein between, as illustrated in FIG. 12A, that is configured to allow a linkage member 152 of the fiber clamp 110 (FIG. 10) to pass through and move laterally about the opening 150. The movement of the linkage member 152 is confined by a T-shaped member 156 being disposed in the cradle member 147 across the two members 148A, 148B when the actuator 58 is not actuated, as illustrated in FIG. 5D, and by the fiber clamp 110 abutting the clamping platform 96 when the actuator 58 is fully actuated, as illustrated in FIG. 9B.

As the actuator 58 is actuated, the end portion 146 of the clamp extension member 146 moves downward towards the fiber clamp 110. The linkage member 152 of the fiber clamp 110 moves through the opening 150 in the cradle member 147. The end portion 146 then applies a force to the fiber clamp 110 to push the fiber clamp 110 onto the clamping platform 96 when the actuator 58 is fully actuated, as illustrated in FIG. 9B. As the actuator 58 is released, the spring 123 causes the shaft 124 and the clamp extension member 144 to move upward away from the cleaving stage platform 62. The cradle member 147 is moved about the linkage member 152 until the members 148A, 148B reach the T-shaped member 156 of the fiber clamping mechanism 112. The cradle member 147 cradles the T-shaped member 156 and pulls upward on the T-shaped member 156 to raise the fiber clamp 110 from the cleaving stage platform 62 until fully raised, as illustrated in FIG. 5D. The T-shaped member 156 is free to rotate inside the cradle member 147 as the cradle member 147 pulls upward on the T-shaped member 156 as the actuator 58 is released.

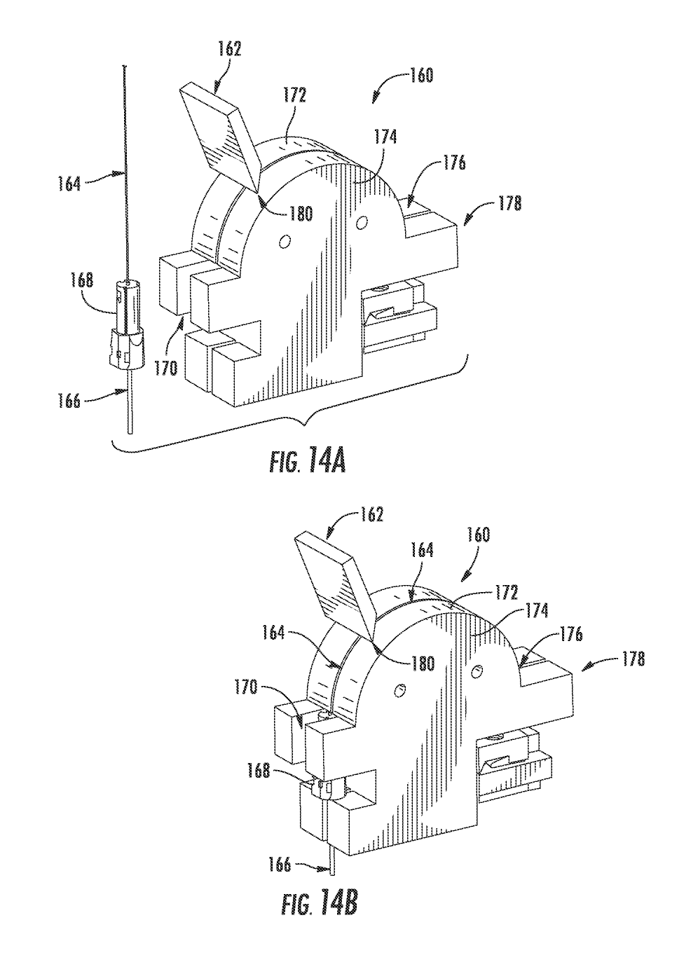

Other cleaver designs are possible that can employ an imbedded carrier blade in addition to the cleaver 50 described above. In this regard, FIG. 14A is a right perspective view of an alternative exemplary cleaver 160 configured to support a blade 162, including an imbedded carrier blade, to cleave an end portion 164 of an optical fiber 166. In this embodiment, the end portion 164 of the optical fiber 166 is stripped to prepare for cleaving and inserted into a fiber holder support 168. FIG. 14A illustrates the cleaver 160 before the fiber holder support 168 holding the end portion 164 of the optical fiber 166 is disposed in a fiber holder 170. As illustrated in FIG. 14B, when the fiber holder support 168 is inserted into the fiber holder 170, the end portion 164 of the optical fiber 166 is disposed on an arcuate surface 172 in a body 174 of the cleaver 160 to place a bend in the end portion 164 of the optical fiber 166 prior to scoring. An end section 176 of the end portion 164 is held in a fiber clamp 178 to provide a stress in the end portion 164. Thereafter, a blade edge 180 of the blade 162 is brought into contact with the end portion 164 of the optical fiber 166 bent about the arcuate surface 172 to induce a flaw in the end portion 164 of the optical fiber 166. The stress placed on the end portion 164 causes the flaw to propagate and break the end portion 164.

The embodiments disclosed herein are not limited to any particular blade, blade material, blade edge section, optical fiber, cleaver carrier, angle of cleaving, stress, fiber stripping, and method of cleaving the optical fiber. The components of the cleavers disposed herein may be constructed out of any material desired. In certain embodiments, disclosed herein, cleaver components are constructed out of polymer-based materials wherein the components are molded. As an example, the cleavers may be comprised of at least ninety percent (90%) polymer-based materials by weight. The cleaved optical fiber ends disclosed herein may be disposed or formed on individual fibers or arrays of fibers. A polishing process may be performed after the optical fiber is cleaved.

As used herein, it is intended that terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A cleaver for cleaving an optical fiber, comprising:
a body;
an actuator disposed in the body and configured to be actuated along an actuation path to move a blade in an at least partially arcuate cleaving path; and
an optical fiber path disposed in the body and intersecting with the at least partially arcuate cleaving path such that an end portion of an optical fiber disposed in the optical fiber path is cleaved when the actuator is actuated moving the blade in the at least partially arcuate cleaving path and contacts the end portion of the optical fiber.

2. The cleaver of claim 1, further comprising a blade arm, said blade arm is movable by the actuator and at least partially supports the blade.

3. The cleaver of claim 2, further comprising a blade housing, said blade housing disposed in the blade arm and configured to hold the blade.

4. The cleaver of claim 3, further comprising a pivot pin, said pivot pin disposed in the blade arm and received in a pivot opening formed in the body and about which the blade arm pivots when the actuator is actuated to cause the blade to move in the at least partially arcuate cleaving path.

5. The cleaver of claim 4, wherein the pivot opening is disposed in a first end cap inserted into a first end opening of the blade housing.

6. The cleaver of claim 5, further comprising a fiber receiver, the fiber receiver disposed in the first end cap configured to receive the end portion of the optical fiber to be cleaved and align the end portion of the optical fiber in the optical fiber path.

7. The cleaver of claim 3, further comprising an articulating pin, the articulating pin disposed in the blade arm and received in a slot disposed in the actuator, wherein the articulating pin traverses the slot when the actuator is actuated to cause the blade to move in the at least partially arcuate cleaving path.

8. The cleaver of claim 7, wherein the slot is disposed along a longitudinal axis intersecting with a longitudinal axis of the actuation path.

9. The cleaver of claim 7, wherein the actuator has a blade arm extension member, and the slot is disposed in the blade arm extension member.

10. The cleaver of claim 9, wherein the blade arm extension member is connected to a yoke disposed in the actuator.

11. The cleaver of claim 1, further comprising a shaft disposed in the actuator, the shaft being configured to move the blade in the at least partially arcuate cleaving path when the shaft is actuated.

12. The cleaver of claim 11, further comprising a cap attached to an end of the shaft to provide an actuation surface for the actuator.

13. The cleaver of claim 1, wherein the actuator is spring-biased.

14. The cleaver of claim 1, further comprising a clamp extension member, the clamp extension member disposed in the actuator and configured to apply a force to a movable fiber clamp to clamp the end portion of the optical fiber disposed in the optical fiber path.

15. The cleaver of claim 14, wherein the actuator is configured to move the blade in the at least partially arcuate cleaving path prior to the clamp extension member applying the force to the movable fiber clamp to clamp the end portion of the optical fiber when the actuator is actuated.

16. The cleaver of claim 14, wherein an end portion of the clamp extension member is configured to apply the force to the movable fiber clamp to clamp the end portion of the optical fiber disposed in the optical fiber path when the actuator is actuated.

17. The cleaver of claim 16, wherein the end portion of the clamp extension member comprises an elastomer.

18. The cleaver of claim 14, wherein the movable fiber clamp is configured to clamp the end portion of the optical fiber to a cleaving stage platform disposed in the body when the actuator is actuated.

19. The cleaver of claim 14, wherein the clamp extension member is connected to a yoke disposed in the actuator.

20. The cleaver of claim 14, further comprising a retention member, the retention member disposed at least partially in the clamp extension member and configured to raise the movable fiber clamp from the end portion of the optical fiber when the actuator is released.

21. The cleaver of claim 20, wherein the retention member comprises a cradle member.

22. The cleaver of claim 20, wherein the retention member is configured to pull up a rotatable beam, the rotatable beam being disposed in the moveable fiber clamp to raise the movable fiber clamp from the end portion of the optical fiber when the actuator is released.

23. The cleaver of claim 22, further comprising an extension member connecting the rotatable beam to a cleaving stage platform, the cleaving stage platform disposed in the movable fiber clamp configured to clamp the end portion of the optical fiber when the actuator is actuated.

24. The cleaver of claim 1 comprising at least ninety percent (90%) polymer-based material by weight.

25. A method of cleaving an optical fiber, comprising:
disposing an end portion of the optical fiber along an optical fiber path disposed in a body of a cleaver; and
actuating an actuator disposed in the body to cause a blade to move in a generally arcuate cleaving path, the generally arcuate cleaving path intersecting with the optical fiber path in a first direction swiping the blade across at least a portion of the end portion of the optical fiber.

26. The method of claim 25, wherein actuating the actuator further comprises moving a movable blade arm supporting the blade in the generally arcuate cleaving path.

27. The method of claim 26, wherein actuating the actuator causes the movable blade arm to rotate above a pivot pin disposed in the movable blade arm and received in a pivot opening.

28. The method of claim 26, wherein actuating the actuator causes an articulating pin disposed in the movable blade arm and received in a slot disposed in the actuator to traverse the slot to cause the blade to move in the generally arcuate cleaving path.

29. The method of claim 25, wherein actuating the actuator causes a clamp extension member disposed in the actuator to apply a force to a movable fiber clamp to clamp the end portion of the optical fiber disposed in the optical fiber path.

30. The method of claim 29, wherein actuating the actuator causes the blade to move in the generally arcuate cleaving path prior to the clamp extension member applying the force to the movable fiber clamp to clamp the end portion of the optical fiber.

31. The method of claim 29, wherein actuating the actuator causes an end portion of the clamp extension member to apply a force to the movable fiber clamp to clamp the end portion of the optical fiber disposed in the optical fiber path.

32. The method of claim 31, wherein actuating the actuator causes the movable fiber clamp to clamp the end portion of the optical fiber to a cleaving stage platform disposed in the body.

33. The method of claim 29, further comprising releasing the actuator to cause the blade to move in the generally arcuate cleaving path in a second direction opposite of the first direction.

34. The method of claim 33, wherein releasing the actuator causes a retention member disposed in the clamp extension member to raise the movable fiber clamp from the end portion of the optical fiber when the actuator is released.

35. A cleaving stage platform for an optical fiber cleaver, comprising:
a support platform comprising:
a first member disposed along a first axis;
a second member disposed along a second axis associated with the first axis;
an opening disposed between the first member and the second member; and
a bridge member, the bridge member connected to first ends of the first member and the second member;
a clamp platform, the clamp platform disposed along a third axis in the opening; and
a living hinge, the living hinge disposed between the bridge member and a first end of the clamp platform such that the clamp platform is resiliently deflectable and movable relative to the bridge member inside the opening when a clamping force is applied to the clamp platform.

36. The cleaving stage platform of claim 35, wherein the first member comprises a first elongated member, and the second member comprises a second elongated member.

37. The cleaving stage platform of claim 35, wherein the first member is disposed along a first longitudinal axis and the second member is disposed along a second longitudinal axis associated with the first longitudinal axis.

38. The cleaving stage platform of claim 35, further comprising at least one fiber stop, the at least one fiber stop disposed in the clamp platform.

39. The cleaving stage platform of claim 35, further comprising at least one fiber stop, the at least one fiber stop disposed in the bridge member.

40. The cleaving stage platform of claim 39, further comprising at least one second fiber stop, the at least one second fiber stop disposed in the cleaving stage platform.

41. The cleaving stage platform of claim 40, wherein the at least one fiber stop disposed in the bridge member and the at least one fiber stop disposed in the cleaving stage platform are aligned in an optical fiber path and configured to retain an end portion of an optical fiber in the optical fiber path.

42. The cleaving stage platform of claim 36, wherein second ends of the first elongated member and second elongated member are attached to an end cap configured to be inserted into a cleaver body of a cleaver to dispose the cleaving stage platform in an optical fiber path of the cleaver.

43. The cleaving stage platform of claim 35, further comprising a hinge receiver, the hinge receiver disposed in the cleaving stage platform and configured to receive a pin of a fiber clamp configured to clamp an end portion of an optical fiber to the cleaving stage platform.

44. The cleaving stage platform of claim 35, further comprising a cleaving channel disposed in the clamp platform configured to allow a blade to pass therethrough to cleave an end portion of an optical fiber disposed across the cleaving channel.

45. The cleaving stage platform of claim 44, wherein the cleaving channel is disposed in the living hinge.

46. The cleaving stage platform of claim 35, the cleaving stage platform being disposed in the optical fiber cleaver.

47. A fiber clamp mechanism for clamping an optical fiber in a cleaver, comprising:
an actuator;
a moveable fiber clamp, the moveable fiber clamp configured to clamp an optical fiber disposed in an optical fiber path in the cleaver when actuated; and
a clamp extension member, the clamp extension member disposed in the actuator and configured to apply a clamping force to the movable fiber clamp and to clamp an end portion of the optical fiber disposed in the optical fiber path in the cleaver.

48. The fiber clamp mechanism of claim 47, wherein an end portion of the clamp extension member is configured to apply a clamping force to the movable fiber clamp to clamp the end portion of the optical fiber disposed in the optical fiber path when the actuator is actuated.

49. The fiber clamp mechanism of claim 48, wherein the end portion of the clamp extension member comprises an elastomer.

50. The fiber clamp mechanism of claim 49, wherein the movable fiber clamp is configured to clamp the end portion of the optical fiber to a cleaving stage platform disposed in the cleaver when the actuator is actuated.

51. The fiber clamp mechanism of claim 47, wherein the clamp extension member is connected to a yoke disposed in the actuator.

52. The fiber clamp mechanism of claim 47, further comprising a retention member, the retention member disposed in the clamp extension member and configured to raise the movable fiber clamp from the end portion of the optical fiber when the actuator is released.

53. The fiber clamp mechanism of claim 52, wherein the retention member comprises a cradle member.

54. The fiber clamp mechanism of claim 52, wherein the retention member is configured to pull up a rotatable beam disposed in the moveable fiber clamp to raise the movable fiber clamp from the end portion of the optical fiber when the actuator is released.

55. The fiber clamp mechanism of claim 54, further comprising an extension member connecting the rotatable beam to a cleaving stage platform disposed in the movable fiber clamp configured to clamp the end portion of the optical fiber when the actuator is actuated.

56. The fiber clamp mechanism of claim 47 disposed in the cleaver.
